(19) United States
(12) Patent Application Publication
(10) Pub. No.: US 2003/0067156 A1
(43) Pub. Date: Apr. 10, 2003

(54) Storage container for paper and other materials

(76) Inventors: James A. Sebastian, Chappaqua, NY (US); Michael McGinn, Brooklyn, NY (US); Agnes de Bethune, Jersey City, NJ (US)

Correspondence Address: WYATT, GERBER & O'ROURKE, L.L.P., ATTORNEYS AT LAW, 99 PARK AVENUE, NEW YORK, NY, 10016, US

(21) Appl. No.: 09/972,833

(22) Filed: Oct. 5, 2001

(51) Int. Cl. B42D 1/00

(52) U.S. Cl. 281/21.1

(57) ABSTRACT

The present invention is directed to an improved apparatus for carrying and/or storing paper and the like. The apparatus is typically a binder for paper and the like that has a first cover and a second cover. The covers are hingedly connected at one of their ends. On the second, or rear cover, usually in the vicinity of the hinged connection of the front and rear cover, there is typically a holding means such as a multi-ring or another type of mechanism for securing the papers and other items in the binder. At least one cover, usually the front, is made up of a material that is relatively flexible. Both covers are preferably provided with a score line extending from the top edge to the bottom edge at their ends opposite their connection. Extending from the score lines on each cover is an end portion that may be used to secure the covers together. The holding means is preferably a “D” shaped ring and one cover, usually the front, wraps itself around the curved segment of the “D”.

### FIELD OF THE INVENTION

The present invention relates to an improved storage container for use with papers and other materials. In particular the present invention is directed to an improved binder and related products.

### BACKGROUND OF THE INVENTION

For many years school children have used a binder for carrying their papers and other things such as pens, pencils, erasers etc. Binders are also used by organizations as a means of storing multi-page documents such as catalogs, operations manuals, correspondence, etc. These binders are typically constructed of three panels: a front cover and rear cover that are slightly larger than the size of the paper that is to be carried in the binder and an end piece, or spine, connecting the front and rear cover. The spine may have on its interior surface a holding means for securing the papers in the binder. One type of binder is the binder that uses two or three rings on the interior wall of the spine or the rear inside cover to hold the papers. Another type of binder may use a clamping means for securing the papers in place. The clamping means is either on the spine or the rear inside cover. There are also available a variety of folders that may also be used to hold papers in position. These folders usually have front and rear covers as does the binder and use pockets to hold the papers in position. When used by children or organizations, binders are often customized through the printing of words and images on the covers.

Currently available binders have a number of issues. One of these relates to the use of rigid covers on the both the front and back covers. Many binders have a front cover and a rear cover that are connected by a relatively wide endpiece that has a ring mechanism attached on the interior wall thereof. When rigid covers are present, the spine where the rings are attached is typically wider than the width of the rings at their widest point. The rigid covers are usually covered cardboard or other rigid but not unbreakable material. The extra width in the spine can be one-half inch or more. This is necessary so that the rigid covers don't become damaged when few papers are present and the front and rear covers are pushed together. The extra width keeps the covers at the tangent formed by the ring and the inside surface of the covers. If this extra width were not present there would be a risk that the metal rings would dent or damage the rigid covers. This extra width for the spine reduces the number of binders that can be placed, for example, on a shelf.

Another issue that arises from prior art binders relates to graphics. There are three separate sections in a traditional binder, the front and rear covers and the spine where the rings are attached. There are limited options available for printing on the covers, particularly rigid covers as well as the spine. For instance, the rigid covers limit the availability of certain printing processes. Furthermore, the limited space available on the spine reduces the possibilities of the printing design. In addition, in the prior art binders the crease between the spine and the cover prevents one from having a smooth flowing design extending from the edge of one cover to the end of the spine that contacts the other cover. Even thinner more flexible covers have graphics issues.

### OBJECTS OF THE INVENTION

It is an object of the invention to provide an improved apparatus for carrying items particular paper and related products.

It is also an object of the present invention to provide an improved binder for carrying items particular paper and related products.

It is another object of the invention to provide a binder that may be secured closed at the opening.

It is still further an object of the invention to provide a large surface, uninterrupted by seams, for customization.

### SUMMARY OF THE INVENTION

The present invention is directed to an improved apparatus for carrying and/or storing paper and the like. In one embodiment, the improved apparatus is a binder for paper and the like that has a unique design. The binder of the present invention has a first cover and a second cover. The front cover and the rear cover are connected and hinged at or in the vicinity of the connection. On the second or rear cover, usually in the vicinity of the hinged connection of the front and rear cover, there is typically a holding means such as rings or another type of mechanism for securing the papers and other items in the binder. At least one cover, usually the front, is made up of a material that is relatively flexible. Alternatively, the first or front cover may be provided with the holding means. In this embodiment the second or rear cover may be flexible.

Both covers are preferably provided with a score line extending from the top edge to the bottom edge at their ends opposite their connection. Extending from the score lines on each cover is an end portion that may be used to secure the covers together. The holding means is preferably a mechanical ring device in the shape of an “O” or “D”. The flexible front cover wraps itself around the curved segment of the device.

### BRIEF DESCRIPTION OF THE DRAWINGS

FIG. 1 is a front perspective view of the binder of the present invention in a closed configuration.

FIG. 2 is a rear perspective view of the binder of the present invention.

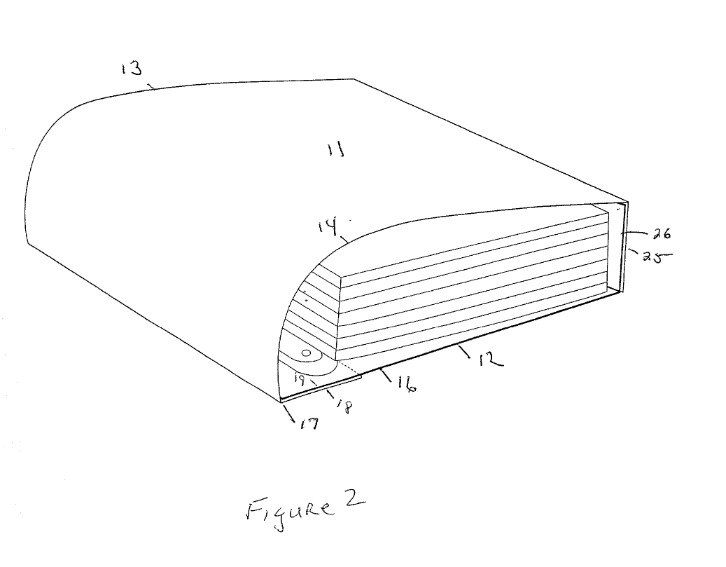

FIG. 3 is a perspective view of the binder of the present invention with the covers in an open position.

FIG. 4 is a end view of the binder of the present invention.

FIG. 5 is a top view of the binder of the present invention with the covers in an open position.

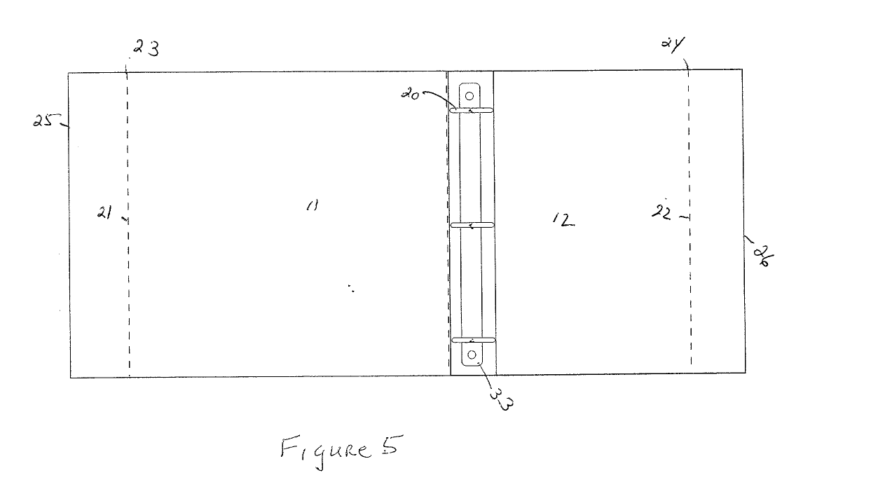

FIG. 6 is a perspective view of an alternate embodiment of the binder of the present invention.

FIG. 7 is an end view of the binder of FIG. 6.

### DETAILED DESCRIPTION OF THE INVENTION

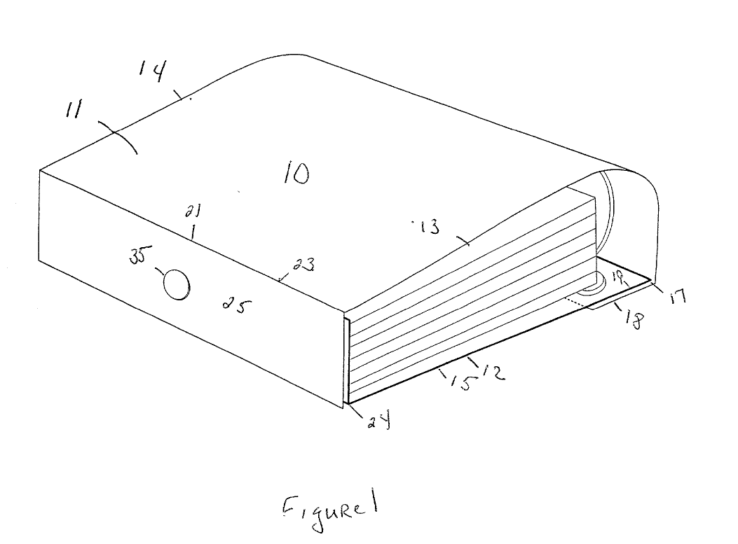

As seen in FIG. 1 there is a binder 10 having a front cover 11 and a rear cover 12. The front cover has a top edge 13 and a bottom edge 14. Similarly, the rear cover has a top edge 15 and a bottom edge 16. The front cover and the rear cover are joined together by a hinged corner 17. The hinged corner can be a score line in the material of the cover that permits the covers to open and close about the corner. Alternatively, the corner can be a hinge that permits the covers to open and close as desired. In a preferred embodiment, the front cover has a front cover portion 18 and the rear cover has a rear cover portion 19 that overlap and provide a region where the front cover and the rear cover may be joined together. Alternatively, the front cover and the rear cover can be a single sheet with a single score line in the sheet about which the front and rear cover can pivot for purposes of opening the binder and accessing the contents.

The material of the covers is preferably a relatively rigid material from the standpoint that it will not tear or rip easily and will generally retain its desired shape. The material should be rigid enough so that it will support a holding means 20. In a preferred embodiment, one cover is rigid and the other is flexible. The rigid cover is preferably the one on which the holding means is attached. The flexible cover, since it is a member separate and distinct from the rigid cover, can undergo a wider variety of graphics treatments including printing because printing for flexible sheets is cheaper and more easily obtained. Having one cover relatively rigid and the other cover flexible may also be cheaper to manufacture in some instances. Also, as seen in the Figures, the flexible sheet is typically larger or longer in length because it drapes around a portion of the rings. This provides greater graphics options for a designer as there is a larger palette to work with. Because a preferred construction of the binder is use two pieces of material, one relatively rigid and one relatively flexible, it is possible to use two materials of different composition. For example, one could if desired, construct the binder with a rigid cardboard rear panel and a transparent plastic front panel. This offers yet additional means for customization.

The holding means may be a two or three ring mechanism as is conventionally used in prior art binders. The rings may be “D” shaped or “O” shaped or any other conventional shapes. Alternatively, the holding means may be a clamping means that retains the material to be stored in the binder between a first plate and a second plate. A mechanism forces the plates toward each other and thereby holds the material there between in position. A locking mechanism can be used to retain the plates in a locked position. The holding means can be positioned anywhere on the relatively rigid cover as is desired. The holding means may also be an accordion type insert that has a plurality of pockets for receiving papers etc. Other holding means may be used as desired. These holding means may include pins, clamps, fixed pocket assemblies, etc.

In a preferred embodiment, the rear cover is preferably a relatively rigid material such as a polypropylene having a thickness of about 0.040 to about 0.010 mil. Other material may include paper, cardboard, plastic coated or covered cardboard, metal, other plastic materials, etc. The front cover is usually made of a less rigid material. While the front cover may also be made of a polypropylene, the thickness may be in the range of 0.010 to about 0.030 mil. One preferred material for both the front and rear cover is a clear polypropylene.

In a preferred embodiment, the front cover 11 and the rear cover 12 each have an end edge 21 and 22 respectively. Extending from the end edge 21 is a spine portion 25 that is hingedly connected to the end edge 21. In a preferred embodiment, the spine portion 25 is connected to the front cover about a score line 23. It will be appreciated by one skilled in the art that the spine portion can be a separate member apart from the cover and attached thereto by a suitable connection means provided the connection means permits the spine to be rotated about the connection means or in the vicinity of the connection means. Similarly, in a preferred embodiment, the rear cover has an end edge 22. Extending from the end edge 22 is spine portion 26 that is connected to the rear cover by score line 24. As with the front cover, the spine portion on the rear cover can be a separate member apart from the cover and attached thereto by a suitable connection means.

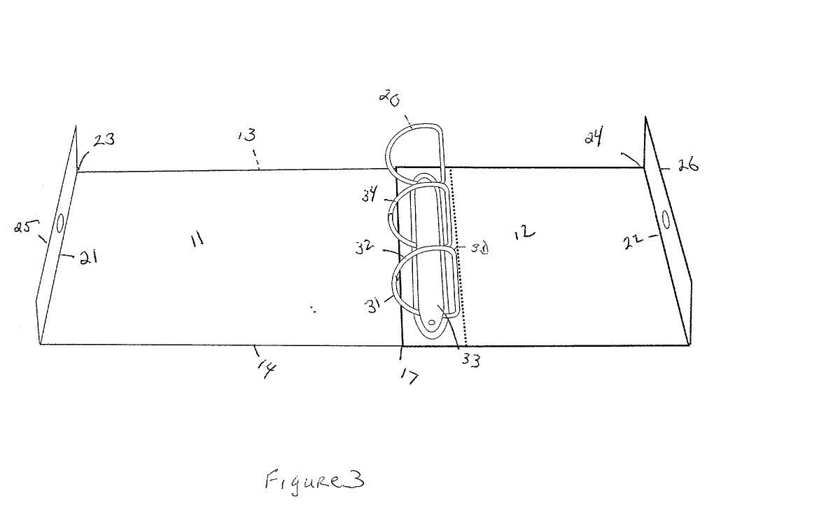

As seen in FIG. 3, the holding means is a plurality of rings 30 that have a first jaw 31 and a second jaw 32. The jaws are positioned on a base 33. The jaws are preferably mounted in the base such that they are usually held in a closed position without becoming separated unintentionally and can be spread apart as it becomes necessary to add paper or other materials to the binder. The rings may be opened individually or there may be a tongue at the top portion of the base and the bottom of the base where generally simultaneous pressure on the tongue forces the jaws to separate to permit the insertion and/or removal of paper or other material.

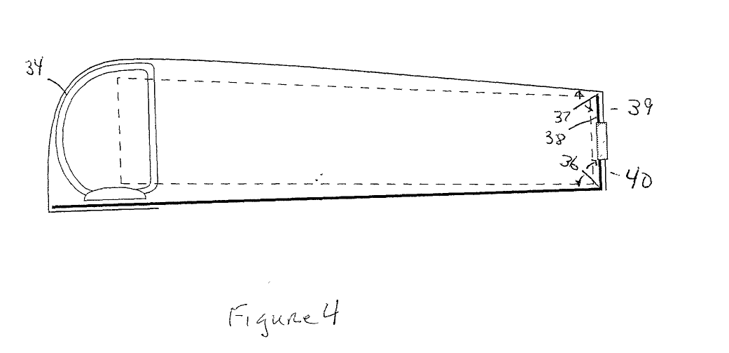

In the preferred embodiment, the rings are generally “D” shaped and positioned with the curved portion of the “D” 34 facing rearwardly, i.e., the straight portion of the “D” is aligned towards the end edges of the front and rear covers. Although the rings are shown with a “D” shape, it will be appreciated that other configurations for the rings are possible. It is preferred, however, that there be a curved portion toward the rear of the binder. The curved portion of the “D” as seen in FIG. 4 is useful as it provides the front cover with a curved area to be folded over when the binder is being closed. This can give the binder a unique shape for the cover where the cover is flexible. The cover having this shape is usually the front cover of the binder but it can also be the rear cover instead.

The flexible, or semi-flexible, front cover offers two distinct advantages that are not present in conventional binders. They are a) the front cover, in wrapping or curving (around the ring mechanism?) to the hinge at the point where it meets the back cover forms a large, uninterrupted surface. Traditional binders feature a scored fold between the front cover panel and the spine panel. Having an unbroken surface is an advantage when considering the need to graphically customize a binder. And b) the flexibility of the front cover permits customization through traditional printing technologies (offset, etc.) as the material behaves much like paper. This is unlike traditional binders of the same size which are constructed of rigid panels and thus limited in the means by which one may customize the surface. There are typically economical advantages to this.

The spine portions 25 and 26 are preferably provided with a means 35 for securing the spine portions together to provide an end 38 for the binder. This end piece 40 formed by the spines is shown more clearly in FIG. 4 where the splines are shown forming an angle 36 and an angle 37 to the front and rear cover approaching 90 degrees and preferably at least one angle is 90 degrees and the other has a range of about 120 degrees to 90 degrees. More preferably, the second angle will have a range of about 110 to 90 degrees and most preferably about 100 to 90 degrees. In a preferred embodiment, the angle 36 between the relatively rigid cover and the end wall 40 is a 90 degree angle. It will be appreciated that the angles 36 and 37 between the end wall 40 and the front and rear cover can vary depending on the amount of material present in the binder. One means for securing the spines together is to use a snap fastener or other securing means such as Velcro, magnets etc., that are known to those skilled in the art. The spine portions 38 and 39 of the covers form an endpiece that is generally flat and can be used as the spine of a book for placing identifying information relating to the contents therein. The spine portions forming the endpiece 40 give the binder a “squared off” appearance.

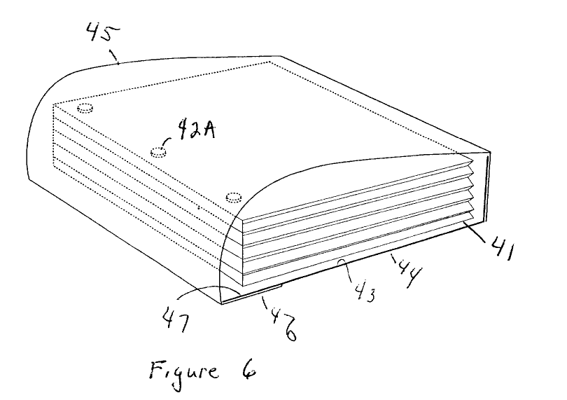

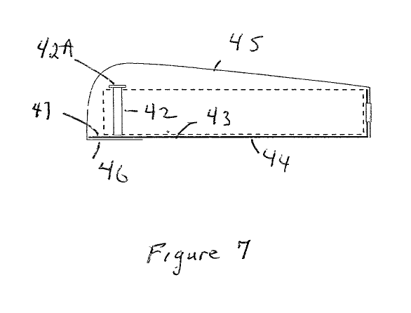

In an alternative embodiment of the present invention, the cover is without the “D” shaped rings. On or a plurality of file type folders may be arranged between the covers. This is shown in more detail in FIGS. 6 and 7. As shown in FIG. 6 there is a file portion 41 that may be a single file folder or a plurality of file folders. In this example there is a single expandable folder. Securing the folder to the binder are one or more posts 42 that are attached to the inside surface 43 of the rigid cover 44. The flexible cover 45 has a flexible cover portion 46 and the rigid cover 44 has a rigid cover portion 47 that overlap and provide a region where the flexible cover and the rigid cover may be joined together. Alternatively, the front cover and the rear cover can be made of the same material or can be a single sheet with a single score line in the sheet about which the front and rear cover can pivot for purposes of opening the binder and accessing the contents. The posts can retain the file or paper or other device that is to be held by the cover. A variety of holding means are possible. As seen in FIGS. 6 and 7 the top 42A of the post 42 has a diameter greater than the diameter of the remainder of the post and this can provide a means of retaining the device whether it be paper, a folder etc. in position. This top member 42A can be a separate member that screws into the post, snaps into the post etc. Alternatively, the top member 42A may be integral with the post and the posts may be removable for inserting the paper, file or other device in position. It will be appreciated that other means for holding can be used other than the posts, including a spiral wire similar to that used on spiral bound notebooks, as well as clamps, clips and so forth.

I claim:

1. An apparatus for holding paper and the like comprising a front cover and a rear cover, said front cover and said rear cover each having a first end and a second end, a top edge and a bottom edge, said front cover having a front cover portion at said first end, said front cover portion being hingedly connected to said front cover, said front cover portion and said rear cover being connected together in a region adjacent the first end of said rear cover, said front cover having at said second end a spine portion hingedly connected thereto and said rear cover having at said second end a spine portion hingedly connected thereto such that said spine portions may be connect together to form an end wall.

2. The apparatus according to claim 1 wherein the rear cover is made from a material that is more rigid than the front cover.

3. The apparatus according to claim 1 wherein one cover is made from a relatively rigid material and the other cover is made from a relatively flexible material.

4. The apparatus according to claim 2 wherein one cover has attached thereto a holding means for securing paper or related materials in the apparatus.

5. The apparatus according to claim 4 wherein the holding means comprises a plurality of rings having jaws that may be separated for the insertion of paper into the ring.

6. The apparatus according to claim 3 wherein the rigid cover has attached thereto a holding means for securing paper or related materials in the apparatus.

7. The apparatus according to claim 6 wherein the holding means comprises a plurality of rings having jaws that may be separated for the insertion of paper into the ring.

8. The apparatus according to claim 7 wherein one cover is flexible and curves around the rings as it extends from the hinged connection with the rear cover.

9. The apparatus according to claim 8 wherein said front and rear spine portions having an inside and an outside surface and wherein said inside surface of said rear spine portion contacts said outside surface of said front spine portion.

10. The apparatus according to claim 8 wherein said front and rear spine portions having an inside and an outside surface and wherein said inside surface of said front spine portion contacts said outside surface of said rear spine portion.

11. The apparatus according to claim 1 wherein the rear cover is semi-rigid and the front cover is semi-flexible.
